(19) United States
(12) Patent Application Publication
(10) Pub. No.: US 2017/0147996 A1
(43) Pub. Date: May 25, 2017

(54) Pseudonymous Discussion Forum System

(71) Applicant: Josh Kirley, Miromar Lakes, FL (US)

(72) Inventor: Josh Kirley, Miromar Lakes, FL (US)

(21) Appl. No.: 15/361,370

(22) Filed: Nov. 25, 2016

Related U.S. Application Data
(60) Provisional application No. 62/308,949, filed on Mar. 16, 2016.
(60) Provisional application No. 62/259,145, filed on Nov. 24, 2015.

(51) Int. Cl. G06Q 20/10; G06F 3/0482; H04L 12/58

(52) U.S. Cl. CPC G06Q 20/10; H04L 51/32; G06F 3/0482

(57) ABSTRACT

A discussion forum system including a central server in communication with a plurality of user devices in which each of the user devices provides a user interface through which an associated user communicates with the central server; the user interfaces facilitate user participation in a plurality of exchanges in which each of the two or more users is represented by a pseudonymous avatar; in which at least a first user and a second user of the two or more users pay a required buy in associated with a first exchange of the plurality of exchanges to join the exchange and the value of each user's buy in is divided amongst a comment bank and a tip bank associated with each user; and in which, users pay from the comment bank to make comments and pay others from their tip bank for quality comments.

### BACKGROUND OF THE INVENTION

The present subject matter relates generally to a system for a pseudonymous, subscription based discussion forum. More specifically, the present invention relates to a system and method improving conversation and collaboration in an online discussion forum by enabling users to reward each other for informative and insightful posts.

Electronic discussion forums hold considerable promise for creating environments that encourage a respectful exchange of ideas amongst users. Unfortunately, users who harass, troll, and otherwise denigrate other users have long plagued previous discussion forums. Although there have been many approaches to dealing with this problem, such as comment moderation, abusive comment reporting, or ignoring the problem, there remains a need for discussion forums that curb abusive users.

One problem with previous discussion systems is open participation has created a crippling inefficiency in the free exchange and growth of ideas in Internet forums. Participants may be hesitant to share their true thoughts and ideas at the risk of being personally identified, or “doxed”. There is a need for discussion forums that protect the anonymity of users.

Additionally, many forums lack thoughtful and insightful comments because there is no incentive for users to provide such commentary. Users often lack a stake in a conversation before joining that conversation. Such users may poison debate, or generally lower the quality of discussion. Thus, there is a need for systems that give users a stake in maintain a positive discussion.

Further, although most initial users in a discussion forum contribute positively to discussions, because there are no mechanisms to reward that behavior, those users may feel unappreciated and may react to less positive contributors by leaving the discussion and thus lowering the quality of the discussion forum overall. Thus, there is a need for discussion forums that reward positive contributions.

Accordingly, there is a need for pseudonymous discussion forum systems that more efficiently facilitate and accelerate conversation and allow for and reward the free exchange of ideas, as described herein.

### BRIEF SUMMARY OF THE INVENTION

To meet the needs described above and others, the present disclosure provides pseudonymous discussion forum systems that more efficiently facilitate and accelerate conversation and allow for and reward the free exchange of ideas. The pseudonymous discussion forum systems may be accessed over the Internet via a web site or mobile application.

By providing a pseudonymous discussion forum system that rewards users who provide insightful commentary, the disclosed invention more efficiently promotes the free exchange of ideas and promotes engaging and thoughtful content.

In one embodiment, the discussion forum system is a pseudonymous, subscription based website that can be accessed from any electronic device with Internet access, including computers, mobile phones, and tablets. The discussion forum system allows users to create individual discussions around a topic. Each individual discussion is called an exchange. Users may comment on the exchange topic and reply to previous comments on the exchange topic.

In one embodiment of the systems provided herein, in order to participate in an exchange, a user must first buy into the exchange. The buy-in may be with real money, virtual currencies, points, or another form of limited resource to properly incentivize users of the system. By permitting a user to participate in only those exchanges for which they have bought into, the discussion forum system requires users to have something at stake in a conversation before joining that conversation. In some embodiments, every exchange may require a different buy-in amount and a user may only buy into an exchange one time. To avoid unwieldy or unending discussions, the number of participants in an exchange may be fixed, and the exchange may end after a period of time. In some examples, at the close of an exchange, users may choose to re-buy and continue the same conversation in a new resource limited, time-limited environment.

Upon buying into an exchange, one portion of the buy-in may be deposited into the user's virtual “comment bank” while the other portion may be deposited into the user's virtual “tip bank.” In some embodiments, one-fifth of the buy-in may go into the users “comment bank,” while four-fifths of the buy-in may go into the users “tip bank.” The money in the “comment bank” and “tip bank” may be used only for that particular exchange. Separate “comment banks” and “tip banks” are created for each exchange the user joins. If the user joins multiple exchanges, each exchange has its own separate “comment bank” and “tip bank.”

The user may use funds from the “comment bank” to provide their own comment or reply to another user's comment. In some embodiments, it may cost the user ten cents to comment and five cents to reply to another user's comment. The user may use funds from the “tip bank” to tip other users for their contributions. In some embodiments, the user may give out tips in increments of five cents. In the event that the user receives tip money, that money is deposited into the “comment bank” that is associated with that discussion, thus giving the user more funds to provide commentary.

One feature of the discussion forum system is anonymity. The forum provides anonymity to all users, thus allowing users to freely express their views and ideas without worry of being discovered. All comments and replies populate pseudonymously. The anonymity ensures that all users, regardless of age, gender, race, education, or career, begin each discussion on equal footing and have equal opportunity to advance the discussion. Anonymity will foster free disclosure and diffuse both negative and positive consequences of open identification.

Another feature of the disclosed embodiment is a reward system that more efficiently incentivizes users to provide engaging and thoughtful content to the discussion. In the reward feature, a user may tip other users for their contributions. The tip may be withdrawn from the tipping user's “tip bank” and be deposited into the other user's “comment bank.” The tips received by users are real money and may be redeemed for cash, or converted to additional participation (i.e. additional funds in their “comment bank” and “tip bank”). The system may be organized in such a manner that, in order to realize the full value of the discussion, users are compelled to tip other users as any funds not distributed from one's tip bank are forfeited at the conclusion of the discussion. In other embodiments, the tip bank funds may carry over from one discussion to the next.

The object of the reward system is to incentivize and reward thoughtful comments. Further, because tipped money may be deposited into a user's “comment bank,” it will funnel the highest quality contributors to the top of the discussion, and also ensure that in a given forum, only the highest quality contributors will be rewarded for their contributions and left with additional funds to comment. As a comment receives more tips, it moves toward the top of the discussion, thus allowing the discussion's best comments to be viewed more frequently.

Users may also have the ability to direct message with other forum users. The exchange may be controlled by the forum moderators to ensure only non-personal, pseudonymous information is automatically exchanged. However, in some embodiments users may use direct messaging to disclose their identities. The information exchanged via direct message may be monitored and controlled or unmonitored and uncontrolled as suitable for a given environment.

In some embodiments, each user account is assigned a random avatar after each user joins and makes his or her first contribution to the discussion. The avatar may be constant for that forum only. If the user buys-in and contributes to another forum, the user will receive a new avatar, thus fully isolating the contributor's comments from different forums. For example, in one exchange, a user's avatar may be “NQAXAU,” while in a second exchange, that user's avatar may be “RWJNS2”

Further, some embodiments may have an avatar-scramble feature wherein each user views another user's avatar differently from other users. For example, in the same discussion, a user's avatar may appear as “6BJHBG” to one user, but “242RED” to another.

Additionally, some embodiments may include an avatar-naming feature wherein users may have the ability to name another user for their own reference. The name one user gives to another user would only be visible to the user providing the name and not to any other user. For example, a user may change another user's avatar from “6BJHBG” to “Daniel,” making it easier to keep track of that user's comments within a specific forum.

A discussion may be, at least in part, user moderated. For example, each displayed comment may include a link for flagging the comment for being in violation of the forum rules. In one example, when a comment is flagged by at least 20% of the users in a given discussion, the comment is automatically removed. In some embodiments, in order to flag a comment for removal, the user doing the flagging must commit some value for the comment bank to do so. For example, it may cost a user a nickel from the comment bank to flag another comment. If the comment if flagged by enough users to exceed the threshold for removal (in one example, exceed 20%), then the users that have flagged the comment get their money back. If the comment is not flagged by enough user to reach the threshold for removal, the user does not receive the money back and it is instead donated to the system. In other embodiments, the threshold for automatic removal and the value required to pledge in order to flag a comment may vary up or down.

In a preferred embodiment, a discussion forum system, or a method of providing a discussion forum, includes: a central server in communication with a plurality of user devices in which each of the user devices provides a user interface through which an associated user communicates with the central server; the user interfaces facilitate user participation in an online discussion forum comprising a plurality of exchanges, in which each of the plurality of exchanges is an online discussion between two or more users in which each of the two or more users is represented by a pseudonymous avatar assigned by the central server at the time each of the two or more users joins one of the plurality of exchanges; in which at least a first user and a second user of the two or more users pay a required buy in associated with a first exchange of the plurality of exchanges to join the exchange and the value of each user's buy in is divided amongst a comment bank and a tip bank associated with each user; and in which, prior to allowing a comment made by the first user to post to the first exchange, the central server debits a first value from the comment bank associated with the first user and, in response to the posting of the comment, provides an opportunity for the second user to reward the first user with a payment from the second user's tip bank to the first user's comment bank.

In some examples, each tip bank is associated with a single exchange and the value associated with each tip bank must be spent during the associated exchange or forfeited when the associated exchange ends.

In some examples, when more than 20% of the users in the first exchange flag the comment for removal, it is automatically removed from the first exchange. The central server may debit a second value from the comment bank of the second user in response the second user flagging the content for removal. The central server may also credit the second value to the comment bank of the second user when the comment is automatically removed from the first exchange.

The pseudonymous avatars assigned by the central server may be consistently displayed for each user such that the pseudonymous avatar assigned by the central server to the first user is displayed consistently to the second user and to a third user. Alternatively, the pseudonymous avatars assigned by the central server may be uniquely displayed for each user such that a pseudonymous avatar of the first user assigned by central server shown on a second user's user interface is not the same as a pseudonymous avatar of the first user assigned by central server shown on a third user's user interface. In still other examples, the pseudonymous avatar of first user assigned by the central server is replaced by a pseudonymous avatar of first user assigned by the second user when viewed on second user's user interface. In still further examples, the pseudonymous avatars assigned by the central server are uniquely displayed for each user in each of a plurality of discussions such that a pseudonymous avatar assigned by central server for the first user in the first exchange is not the same as a pseudonymous avatar assigned by the central server for the first user in a second exchange.

In addition to the buy in, each exchange may include a minimum number of users participating in the conversation and a maximum number of users participating in the conversation.

As shown, one of the key objectives of the system described herein is that the contributions are “unattributed” to a person.

An object of the disclosed embodiment is to facilitate and accelerate conversation and collaboration in an Internet discussion forum through anonymity and a monetary recognition system that rewards insightful and thoughtful comments.

One advantage of the disclosed invention is it provides complete anonymity to all users. This allows all users to provide unfiltered commentary without worry of being discriminated against because of their personal views. The anonymity feature protects each user from any personal retaliation because of their beliefs.

Another advantage of the disclosed invention is it provides for a subscription based discussion forum system that includes a monetary recognition system that rewards users who provide more insight and better commentary than other users. Each user has a “tip bank” that allows them to tip users they believe provided high quality commentary. When a user receives a tip, they can deposit it into their own “comment bank” giving them more funds to provided additional commentary. This ensures that only the most insightful users are funneled to the top of the discussion forum.

Yet another advantage of the invention is that a user's avatar is reset with every new forum the user joins, further strengthening users' anonymity.

Yet another advantage of the disclosed invention is the avatar-scramble feature wherein users in the same discussion view each other user's avatars differently, further strengthening users' anonymity.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing Figs. depict one or more implementations in accord with the present concepts, by way of example only, not by way of limitations. In the Figs., like reference numerals refer to the same or similar elements.

FIG. 1 is a schematic representation of a discussion forum system.

FIG. 2 is a screenshot of an application embodying the discussion forum system of FIG. 1.

FIG. 3 is a screenshot of a main menu in the application of FIG. 2.

FIG. 4 is a screenshot of an active exchanges window in the application of FIG. 2.

FIG. 5 is a screenshot of an upcoming exchanges window in the application of FIG. 2.

FIG. 6 is a screenshot of an active exchanges window, sorted from newest to oldest, in the application of FIG. 2.

FIG. 7 is a screenshot of an active exchanges window, sorted from most trending to least trending, in the application of FIG. 2.

FIG. 8 is a screenshot of an active exchanges filter window in the application of FIG. 2.

FIG. 9 is a screenshot of an upcoming exchanges window in the application of FIG. 2.

FIG. 10 is a screenshot of an upcoming exchanges filter window in the application of FIG. 2.

FIG. 11 is a screenshot of a join exchange window displaying a form to join an exchange in the application of FIG. 2.

FIG. 12 is a screenshot of a create exchange window displaying a form to create an exchange in the application of FIG. 2.

FIG. 13 is a screenshot of an expanded category dropdown list of the window of FIG. 12.

FIG. 14 is a screenshot of an expanded number of seats dropdown list of the window of FIG. 12.

FIG. 15 is a screenshot of an add funds window in the application of FIG. 2 including a form to add funds to the user's account.

FIG. 16 is a flow chart illustrating how a user's funds are distributed within the system of FIG. 1.

FIG. 17 is a screenshot of an avatar-reset feature in the application of FIG. 2.

FIG. 18 is a screenshot of an avatar-scramble feature in the application of FIG. 2.

FIG. 19 is a screenshot of an avatar-naming feature in the application of FIG. 2.

### DETAILED DESCRIPTION OF THE INVENTION

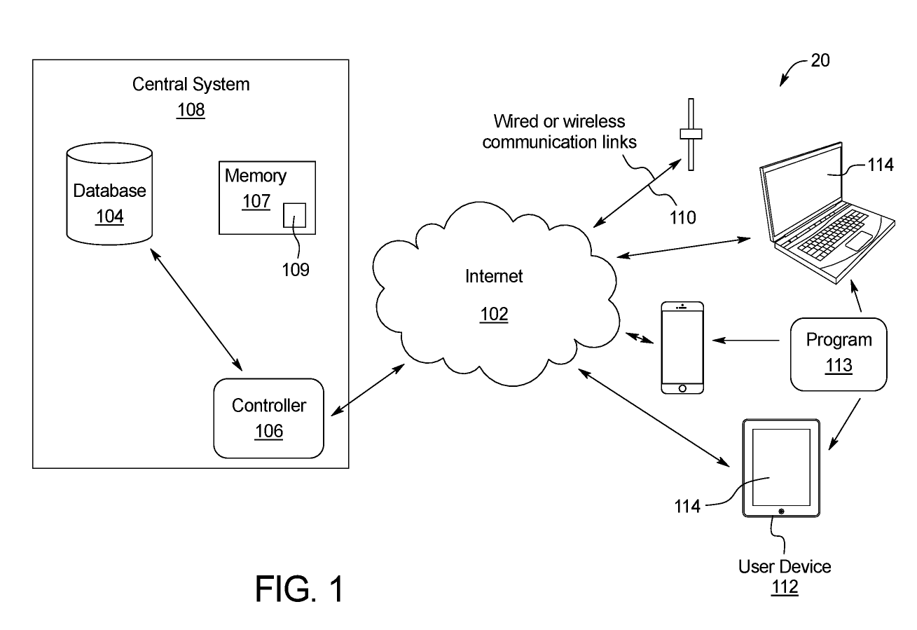

FIG. 1 illustrates an example of the components of a discussion forum system 20 (system 20) embodying the unique features and functions described herein. In the embodiment shown, users use their user devices 112 to participate in exchanges. Because the exchanges are typically online electronic-based discussions, the user devices 112 may be any device that enables its user to communicate in an online discussion, including devices such as smartphones, laptop computers, tablet computers, smartwatches, and the like.

As further shown, a central system 108 coordinates the discussions by communicating with the user devices 112. The central system 108 may be a server including software instructions 109 run by a controller 106 that communicates with user devices 112 through the Internet 102. A database 104 in communication with the central system 108 may store data relating to the operation of the discussion forum system 20, as will be recognized by those skilled in the art based on the descriptions provided herein. Wired or wireless communications links 110 relay communication between the user devices 112, the Internet 102, and the central system 108.

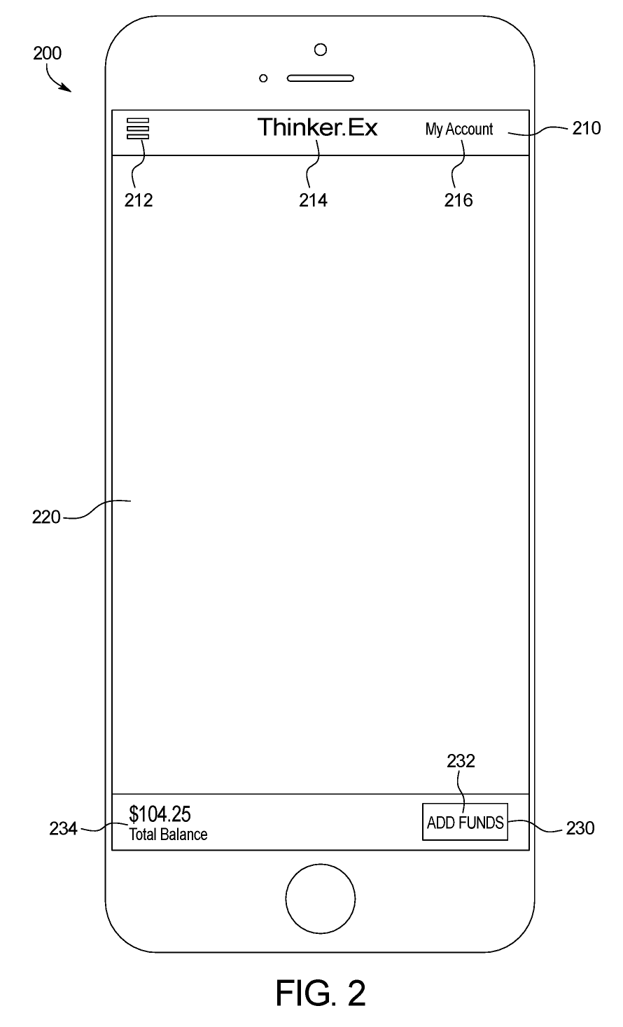

Each user accesses and interacts with the discussion forum system 20 through a user interface 114 provided on a user device 112. In some examples, the user device 112 accesses a web page provided by the central system 108 that provides the user interface 114 described herein. In other examples, the user device 112 executes a program 113 that provides the user interface 114. The user interface 114 provides the features and functions of the discussion forum system 20, as further described herein with reference to FIGS. 2-19.

FIG. 2 illustrates an exemplary wireframe template 200 of the user interface 114 as provided through a user device 112. As shown, the wireframe template 200 includes a top menu bar 210, a main element 220, and a bottom menu bar 230.

In the example shown, the top menu bar 210 includes a menu icon 212, a main menu hyperlink 214, and a “My Account” hypertext 216. When selected, the menu icon 212 displays hypertexts that link to various windows within the user interface 114. The main menu hyperlink 214, which may be in the form of a hypertext with the name of the program 113 as the display text, links to the main menu of the user interface 114. The “My Account” hypertext links to the user's account page. The account page may give the user the ability to update a user profile, update the user's billing information, add and withdraw funds, view a transaction history, and delete the account. The top menu bar 210 is generally locked near the top of the user interface 114 and, in the example provided in FIGS. 2-19, is visible in all active windows in the user interface 114. Within the user interface 114, the main element 220 generally provides the user the main content for each specific window.

In the example shown in FIG. 2, the bottom bar menu 230 includes an “Add Funds” button 232 and a “Total Balance” text area 234. The “Add Funds” button 232 links to an aspect of the user interface 114 from which the user can add funds to the user's account. The “Total Balance” text area 234 displays the total funds currently available in the user's account. The bottom menu bar 210 is generally locked near the bottom of the user interface 114 and is visible in all active windows in the user interface 114.

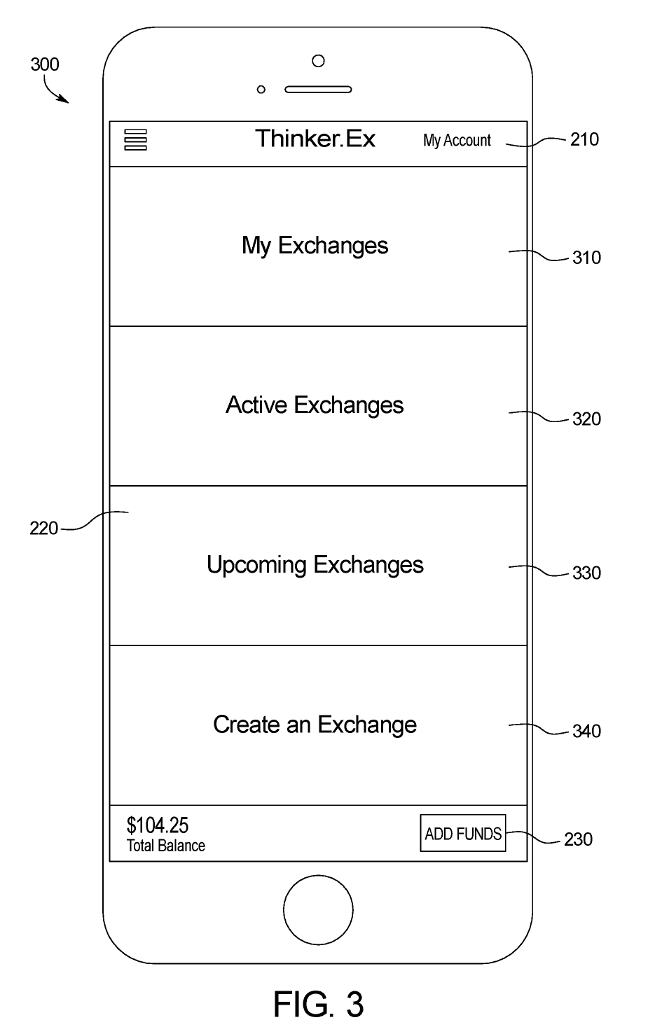

FIG. 3 illustrates an exemplary layout for a main menu 300 in the user interface 114. The main menu 300 includes the top menu bar 210, the main element 220, and the bottom menu bar 230. The main menu window 300 provides links to various aspects of the user interface 114.

As shown, the main element 220 of the main menu 300 includes a “My Exchanges” button 310, an “Active Exchanges” button 320, an “Upcoming Exchanges” button 330, and a “Create an Exchange” button 340. The buttons 310, 320, 330, and 340, link to the aspects of the user interface 114 associated with each respective button. For example, the “My Exchanges” button 310 links to the “My Exchanges” window in user interface 114.

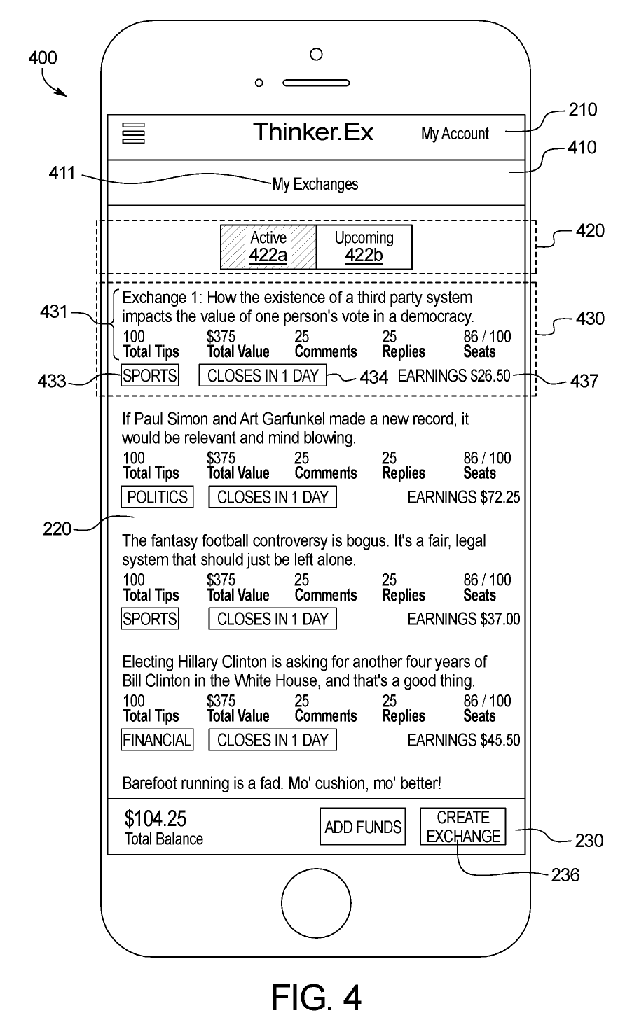

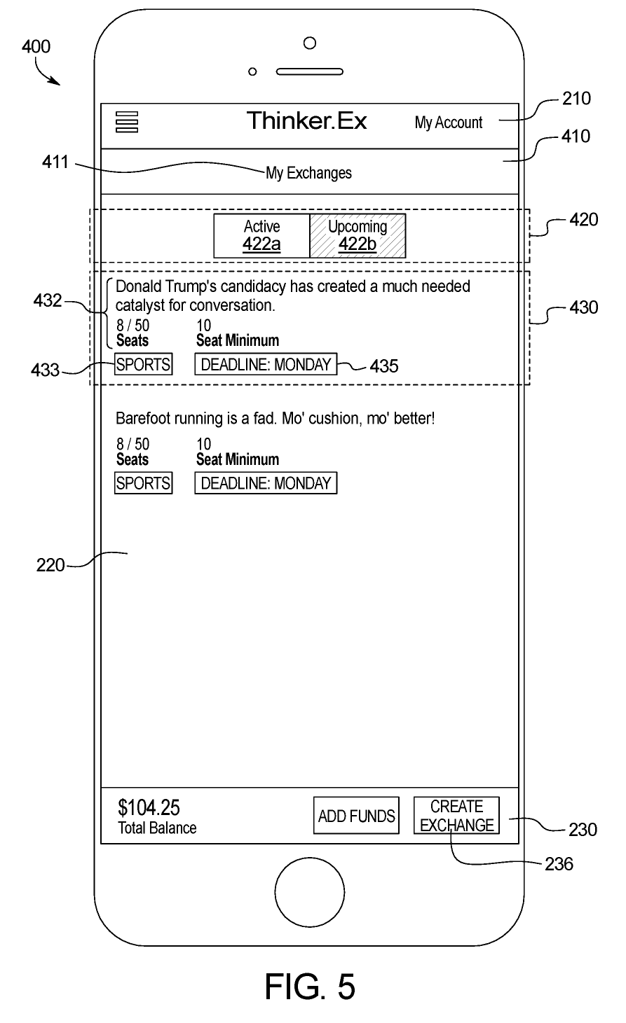

FIGS. 4 and 5 illustrate an exemplary layout of the user interface 114 for the “My Exchanges” window 400. The “My Exchanges” button 310 on the main menu 300 links to the “My Exchanges” window 400. The “My Exchanges” window 400 includes the top bar 210, the main element 220, and the bottom bar 230. The bottom menu bar 230 may include a “Create Exchange” 236 button that links to a window from which the user can add funds to the account.

Generally, the main element 220 of the “My Exchanges” window displays a list of active and upcoming exchanges that the user has joined. An active exchange is an exchange that is still in progress, while an upcoming exchange is an exchange that is yet to begin.

In the example shown, the main element 220 of the “My Exchanges” window 400 includes a title bar 410 that appears below the top menu bar 210. The title bar 410 includes a title text area 411 that displays a title for the active window. The title text area 411 in the “My Exchanges” window 400 may display the text “My Exchanges.”

The main element 220 of the “My Exchanges” window also includes a selection pane 420, which provides an “Active” button 422a and an “Upcoming” button 422b. When the user selects the “Active” button 422a, the “My Exchanges” window 400 displays a list of ongoing exchanges the user has joined (FIG. 4). When the user selects the “Upcoming” button 422b, the “My Exchanges” window 400 displays a list exchanges the user has joined, but have not yet started (FIG. 5).

As additionally shown, the main element 220 of the “My Exchanges” window may provide at least one exchange information box 430 that provides information relating to each particular exchange, including a title, brief summary, and category of the exchange.

FIG. 4 illustrates an exemplary layout of the “My Exchanges” window 400 for when the user selects the “Active” button 422a. When the button 422a is selected, it may appear as a different color than the “Upcoming” button 422b. Additionally, when the “Active” button 422a is selected, the main element 220 displays a list of open exchanges the user has joined.

Further, when the “Active” button 422a is selected, the exchange information boxes 430 may include an active exchange description 431, a “category” textbox 433, a “closing time” textbox 434, and an “earnings” textbox 437. The active exchange description 431 may include a brief description of the exchange along with information regarding the total tips given out in the exchange, the total value of those tips, the number of total comments and replies in the exchange, and the total number of users who have joined the exchange. The active exchange description 431 may also serve as a hypertext that directs the user to the particular exchange. The “category” textbox 433 displays the classification (e.g. sports, politics) of the exchange. The “closing time” textbox 434 provides the number of days before the exchanges closes; while the “earnings” textbox 437 displays the total earnings the user has obtained from that particular exchange.

FIG. 5 illustrates an exemplary layout of the “My exchanges” window 400 for when the user selects the “Upcoming” button 422b. When the button 422b is selected, it may appear as a different color than the “Upcoming” button 422a. Additionally, when the “Upcoming” button 422b is selected, the main element 220 displays a list of upcoming exchanges the user has joined. In an embodiment, upcoming exchanges are exchanges that have not yet had a sufficient number of users join to make the exchange and active exchange.

Further, when the “Upcoming” button 422b is selected, the exchange information boxes 430 may include an upcoming exchange description 432, the “category” textbox 433, and a “deadline” textbox 435. The upcoming exchange description 432 may include a brief description of the exchange along with information regarding the number of users who have joined the exchange, the maximum number of users allowed in the exchange, and the minimum numbers of users required to activate the exchange. The “category” textbox 433 displays the classification (e.g. sports, politics) of the exchange. The “deadline” textbox 435 provides the deadline for when the exchange must meet the required number of users to become active.

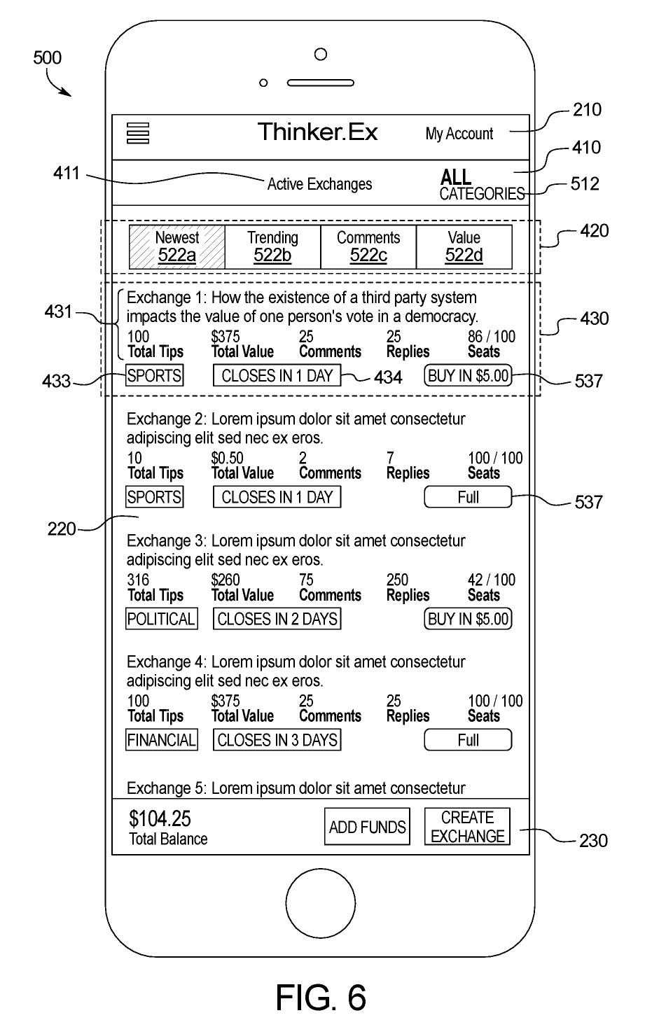

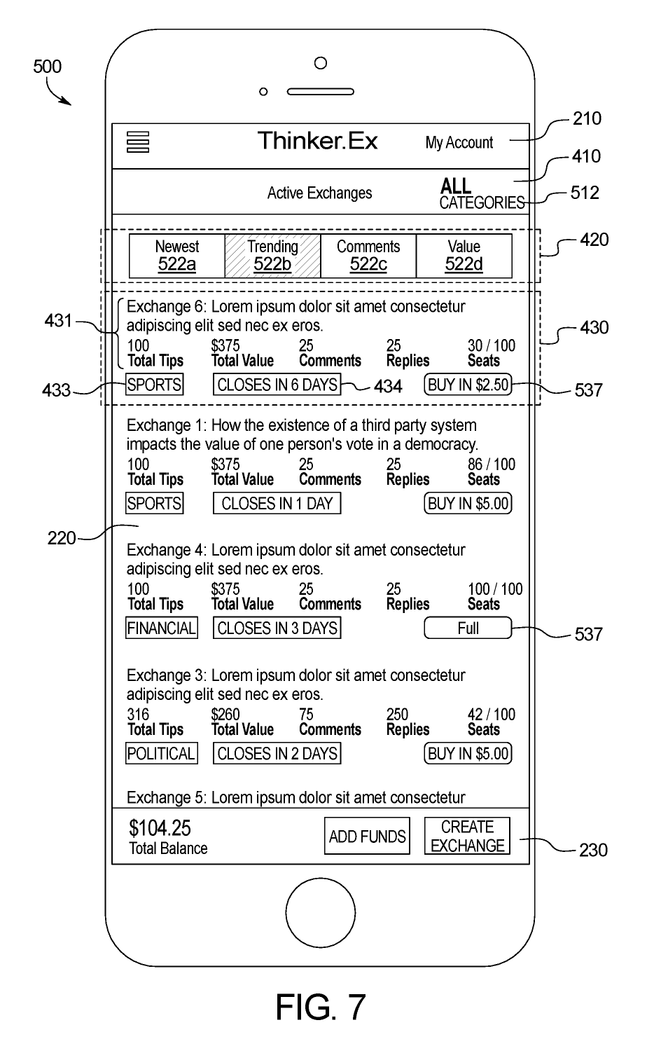

FIGS. 6 and 7 illustrate an exemplary layout of the user interface 114 for the “Active Exchanges” window 500. The “Active Exchanges” button 320 on the main menu 300 links to the “Active Exchanges” window 500. The “Active Exchanges” window 500 includes the top menu bar 210, the main element 220, and the bottom menu bar 230.

Generally, the main element 220 of the “Active Exchanges” window 500 displays a list of all active exchanges. An active exchange is an exchange that is still in progress, with users leaving comments and responding to comments.

The main element 220 of the “Active Exchanges” window 500 may include the title bar 410 that appears below the top menu bar 220. The title bar 410 may include the title text area 411, which displays the text “Active Exchanges” and a “Categories” hypertext 511. The “Categories” hypertext 511 allows the user to filter exchanges based on category. As a default, the “Active Exchanges” window 500 may display exchanges from all categories.

The middle section 220 may also include the selection pane 420 that provides a “Newest” button 522a, a “Trending” button 522b, a “Comments” button 522c, and a “Value” button 522d.

When the user selects the “Newest” button 522a, the “Active Exchanges” window 500 displays all current active exchanges sorted from newest to oldest. When the user selects the “Trending” button 522b, the “Active Exchanges” window 500 displays all current active exchanges sorted by the most trending exchange to the least trending exchange. Trending exchanges may include those with the highest number of buy-ins in during a period (such as a day, week, etc.), the most comments in a period, the most replies in a period, etc. When the user selects the “Comments” button 522c, the “Active Exchanges” window 500 displays all current exchanges sorted by the exchange with the highest number of comments to the exchange with the lowest number of comments. When the user selects the “Value” button 522d, the “Active Exchanges” window 500 displays all current exchanges sorted by the exchange with the highest value to the exchange lowest value. Value for an exchange is that amount of available tips to be awarded to comments for that exchange.

Additionally, the middle section 220 of the “active exchanges” website 500 may include one or more exchange information boxes 430 that provide information for that particular exchange, including the title, brief summary, and category of the exchange.

FIG. 6 illustrates an exemplary layout of the “Active Exchanges” window 500 for when the user selects the “Newest” button 522a. When the button 522a is selected, the exchanges are sorted from newest to oldest. Additionally, when the “Newest” button 522a is selected, it may appear as a different color than the buttons 522b, 522c, and 522d.

Further, when the “Newest” button 522a is selected, the exchange information boxes 430 may include the active exchange description 431, the “category” textbox 433, the “closing time” textbox 434, and a “Buy In” button 537.

The active exchange description 431 may include a brief description of the exchange along with information regarding the total tips given out in the exchange, the total value of those tips, the number of total comments and replies, and the total number of users who have joined the exchange. The “category” textbox 433 displays the classification (e.g. sports, politics) of the exchange. The “closing time” textbox 434 provides the number of days before the exchanges closes. The “Buy In” button 537 provides a link to a separate window that allows the user to join that exchange. However, in a case where the exchange is full, and thus not able to be joined, the “Buy In” button may deactivate and display the text “Full”.

FIG. 7 illustrates an exemplary layout of the “Active Exchanges” window 500 for when the user selects the “Trending” button 522b. When the button 522b is selected, the exchanges are sorted from more trending to least trending. Additionally, when the button 522b is selected, it may appear as a different color than the buttons 522a, 522c, and 522d.

Further, when the “Trending” button 522b is selected, the exchange information boxes 430 may include the active exchange description 431, the “category” textbox 433, the “closing time” textbox 434, and the “Buy In” button 537.

The active exchange description 431 may include a brief description of the exchange along with information regarding the total tips given out in the exchange, the total value of those tips, the number of total comments and replies, and the total number of users who have joined the exchange. The “category” textbox 433 displays the classification (e.g. sports, politics) of the exchange. The “closing time” textbox 434 provides the number of days before the exchanges closes. The “Buy In” button 537 provides a link to a separate page that allows the user to join that exchange. However, in a case where the exchange is full, and thus not able to be joined, the “Buy In” button may deactivate and display the text “Full.”

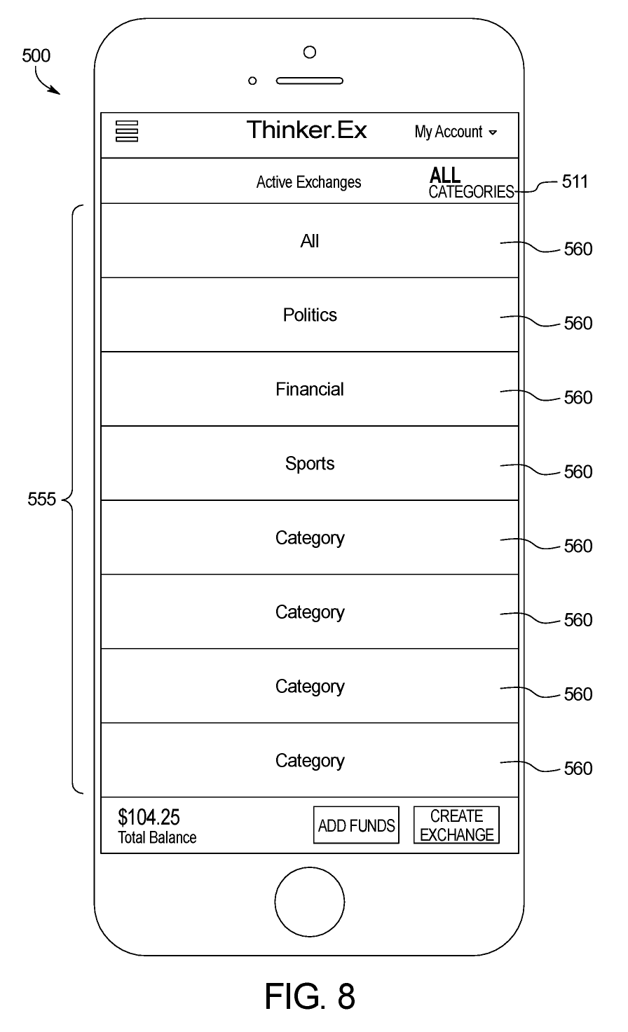

FIG. 8 illustrates an exemplary layout of the user interface 114 of the “Active Exchanges” category filter dropdown menu 555. When the user selects the “Categories” hypertext 511, the “Active Exchanges” window displays the dropdown menu 555. The dropdown menu 555 includes one or more “category selection” filter boxes 560 (e.g. all, politics, financial, sports). When the user selects a filter box 560, the dropdown menu 555 closes and the “Active Exchanges” window 500 will only display exchanges from that category. Additionally, the “Categories” hypertext 511 may display text of the category the user is currently browsing.

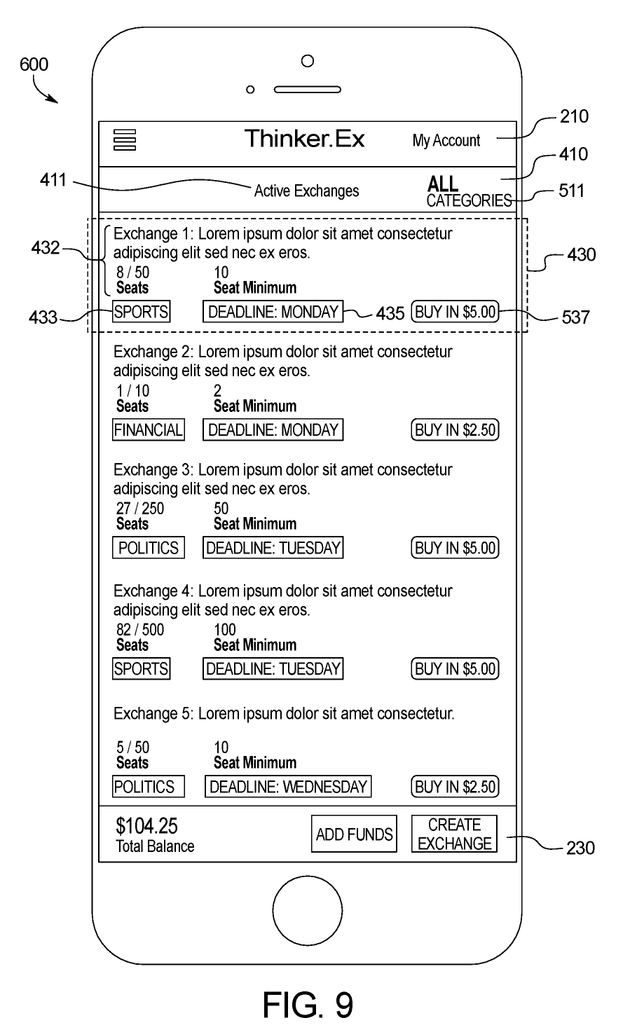

FIG. 9 illustrates an exemplary layout of user interface 114 for the “Upcoming Exchanges” window 600. The “Upcoming Exchanges” window 600 includes the top menu bar 210, the main element 220, and the bottom menu bar 230. Generally, the main element 220 of the “Upcoming Exchanges” window 600 provides a list of all upcoming exchanges.

The main element 220 of the “Upcoming Exchanges” window 600 may include the title bar 410 that appears below the top menu bar 220. The title bar 410 may include the title text area 411, which displays the text “Upcoming Exchanges” and the “Categories” hypertext 511. The “Categories” hypertext 511 allows the user to filter exchanges based on category. As a default, the “Upcoming Exchanges” window 600 may display exchanges from all categories.

The middle section 220 of the “Upcoming Exchanges” window 600 may include one or more exchange information boxes 430. The information boxes 430 include the upcoming exchange description 432, the “category” text box 433, the “deadline” textbox 435, and the “Buy In” button 537.

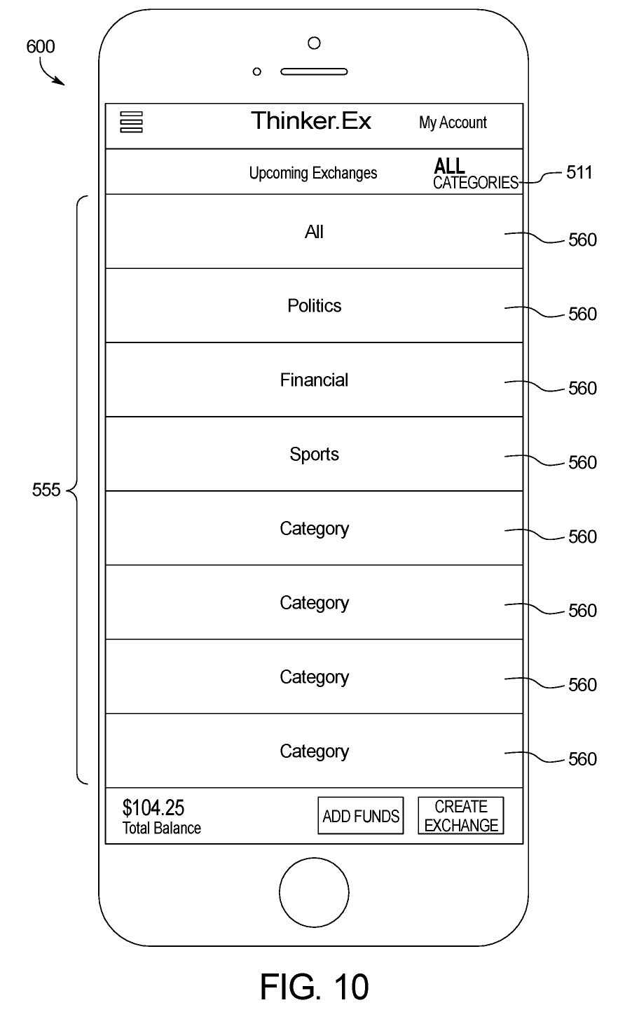

FIG. 10 illustrates an exemplary layout for the user interface 114 of the “Upcoming Exchanges” window category filter dropdown menu 555. When the user selects the “Categories” button 511, the “Upcoming Exchanges” window displays the dropdown menu 555. The dropdown menu 555 includes one or more “category selection” filter button 560 (e.g. all, politics, financial, sports). When the user selects a filter box 560, the dropdown menu 655 will close and the “Upcoming Exchanges” window 600 will only display exchanges from that category. Additionally, the “categories” button 511 may display text of the category the user is currently browsing.

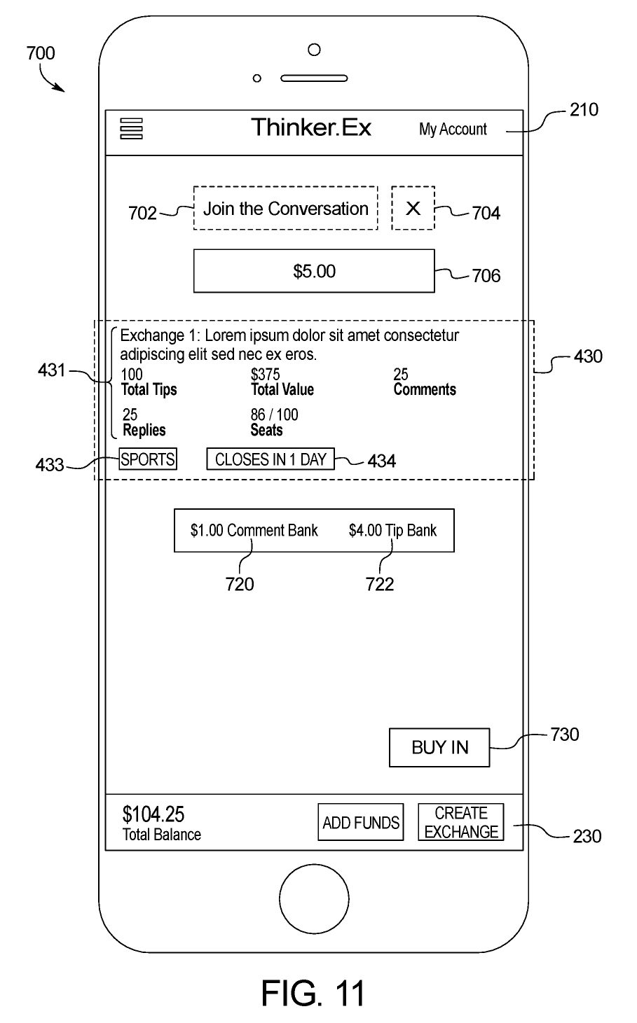

FIG. 11 illustrates an exemplary user interface 114 of the “Buy In” window 700. The “Buy In” button 537 as seen in FIGS. 6,7, and 9 link to the “Buy In” window 700. The “Buy In” window 700 may include the top menu bar 210, the main element 220, and the bottom menu bar 230.

The middle section 220 of the “Buy In” window 700, may include a title box 702, a cancel button 704, an “amount” textbox 706, the exchange information box 430, a “comment bank” textbox 720, a “tip bank” text box, and “Buy In” submit button 730.

The title box 702 may display text indicating the purpose of the page, for example, the title box 702 may display the text, “Join the Conversation.” The cancel button 704, if selected by the user, directs the user back to the list of exchanges. The “amount” textbox 706 displays the total buy in needed for that particular exchange. The exchange information box 430 includes the upcoming exchange description 432, the “category” textbox 433, and the “closing time” textbox 434. The “comment bank” textbox 720 displays the amount of the buy in that will be deposited into the user's comment bank. The “tip bank” textbox 722 displays the amount of the buy in that will be deposited into the user's tip bank. The “buy in” submit button 730, when selected by the user, submits the user's request to join the desired exchange.

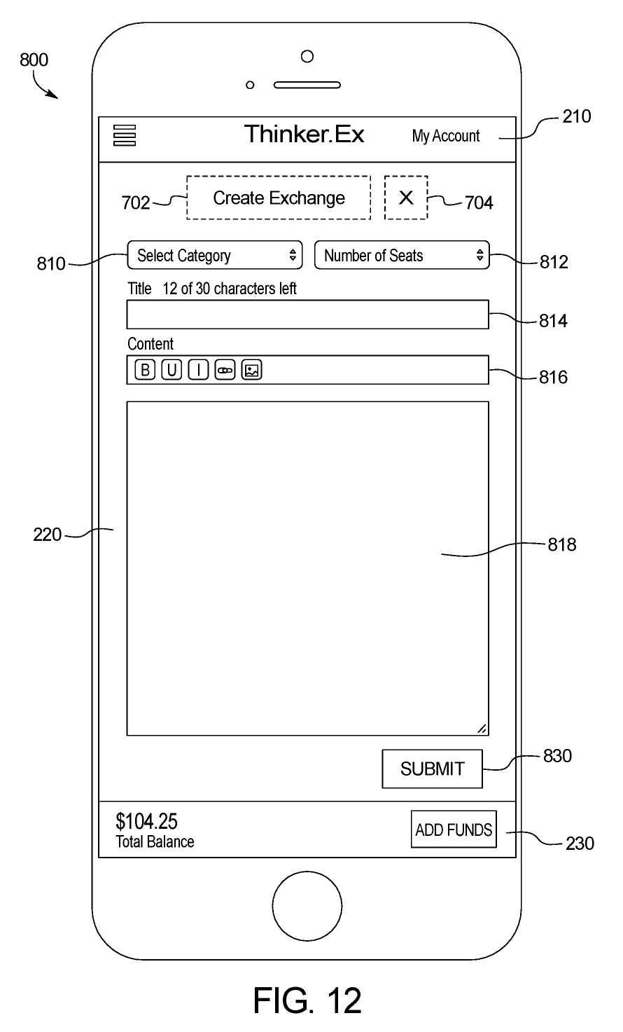

FIGS. 12, 13, and 14 illustrates an exemplary layout of the user interface 114 for a “Create Exchange” window 800. The “Create Exchange” button 340 on the main menu window 300 and “Create Exchange” button 236 on the bottom menu bar 230 link to the “Create Exchange” window 800. The “Create Exchange” window 800 allows the user to submit a web form to create an exchange. The window 800 may include the top menu bar 210, the main element 220, and the bottom menu bar 230.

The main element 220 of the “Create Exchange” window 800 may include the title textbox 702, the close button 704, a “Select a Category” dropdown list 810, a “Number of Seats” dropdown list 812, a “Title” text input field 814, a “Content” formatting menu, a “Content” text input field 818, and a “Create Exchange” submit button 830.

The title textbox 702 may display text indicating the purpose or title of the page, for example, on the “Create Exchange” window 800, the title box 702 may display the text, “Create Exchange.” The cancel button 704 closes the “Create Exchange” window and directs the user back to the home screen page 300. The “category” selection dropdown list 810 allows the user to classify the exchange from set of categories that have been predefined by the program 113. The “Number of Seats” selection dropdown list 812 allows the user to define seat and buy-in requirements from a set of predefined requirements from program 113.

The user can add the title of the exchange to the “Title” text input field 814 and a description of the exchange in the “Content” text input field 818. The “Content” formatting menu allows the user to format the text in the “Content” text input field 818 and also add hyperlinks and images to the text input field 818.

“Create Exchange” submit button 830 allows the user to submit their request to create the exchange.

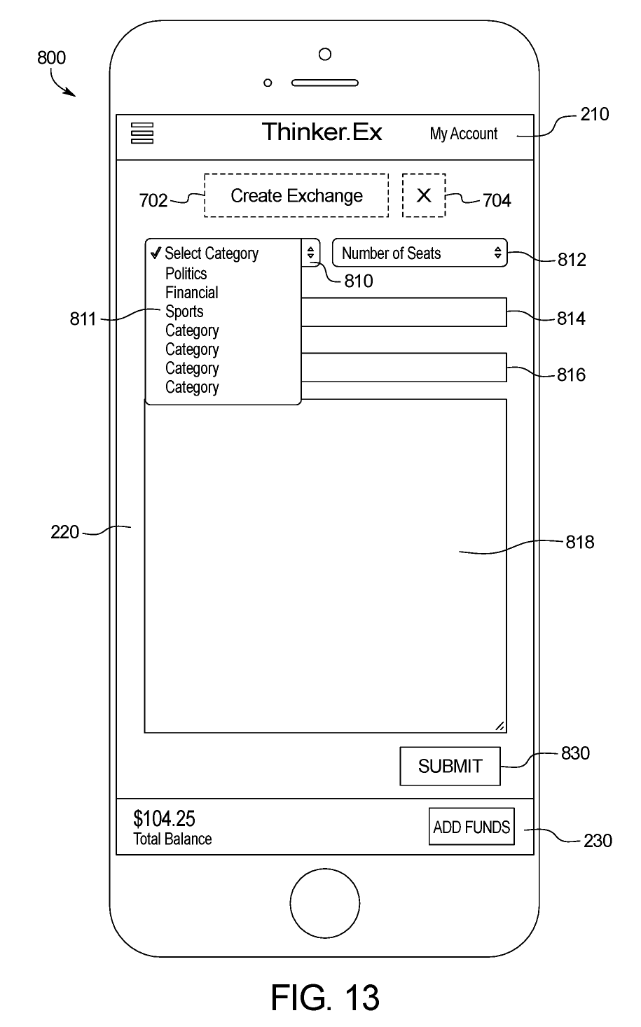

FIG. 13 illustrates an exemplary layout of the “Create Exchange” window 800 with the “Select Category” dropdown list 810 expanded. The expanded “Select Category” dropdown list 811 lists a variety of categories, including politics, financial, and sports that the user can use to classify their exchange.

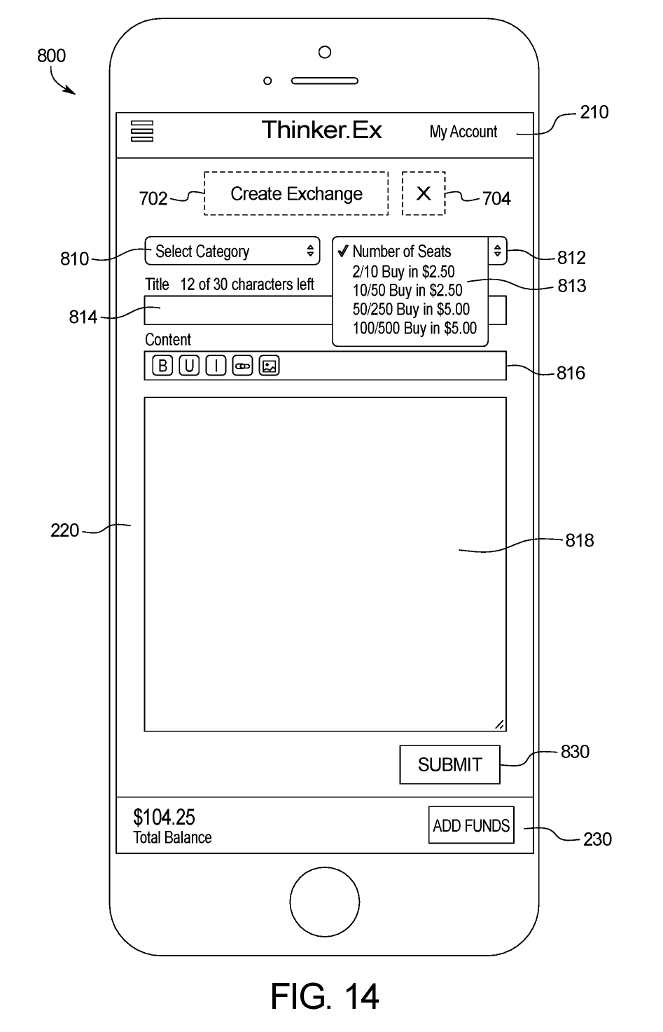

FIG. 14 illustrates an exemplary layout of the “Create Exchange” window 800 with the “Number of Seats” dropdown list 811 expanded. The expanded “Number of Seats” dropdown list 813 includes requirements relating to the number of seats that must be filled before the exchange is activated, the maximum number of seats, and the buy in amount. For example, a “2/10 Buy-in $2.50” selection requires at least 2 filled seats, caps the total number of seats at 10, and requires a $2.50 buy in.

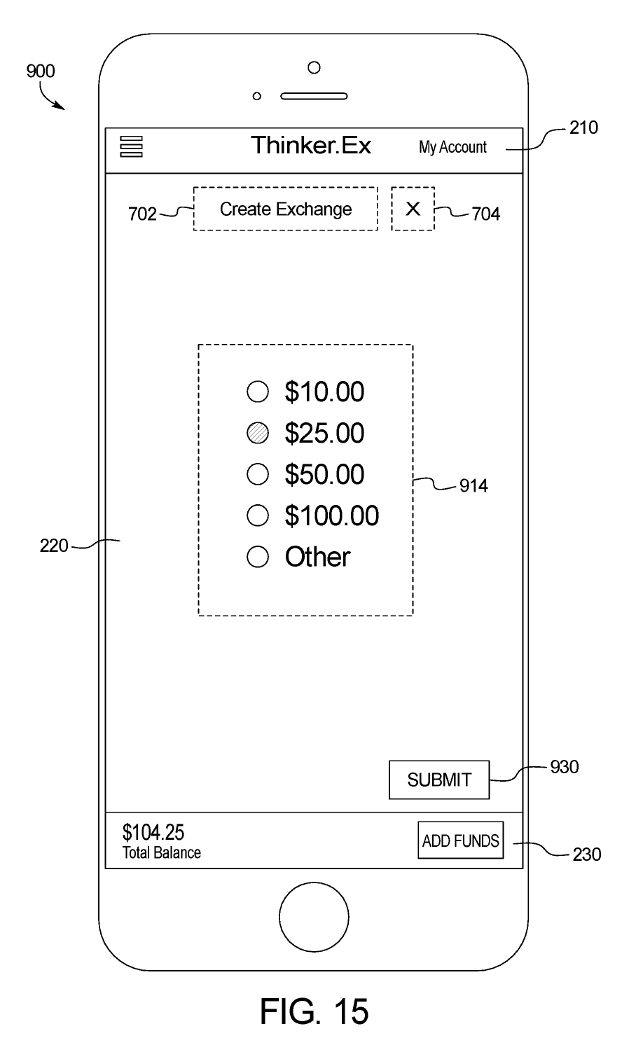

FIG. 15 illustrates an exemplary layout of the user interface 114 for an “Add Funds” window 900. The “Add Funds” button 232 on the bottom menu 230 links to the “Add Funds” window 900.

The “Add Funds” window 900 allows the user to submit a form to add funds to their account. The window 900 may include the top menu bar 210, the main element 220, and the bottom menu bar 230.

The main element 220 of the “Add Funds” window 900 may include a title textbox 702, a close button 704, deposit amount radio buttons 914 and a “Add Funds” submit button 930. The title textbox 702 may display text indicating the purpose or title of the webpage, for example, on the “Add Funds” window 900, the title box 702 may display the text, “Add Funds.” The cancel button 704 closes the “Add Funds” window and directs the user back to the previous active window. The radio button 914 allow the user to select a pre-defined amount or input another amount. The “Add Funds” submit button allows the user to submit their request to add funds to their account.

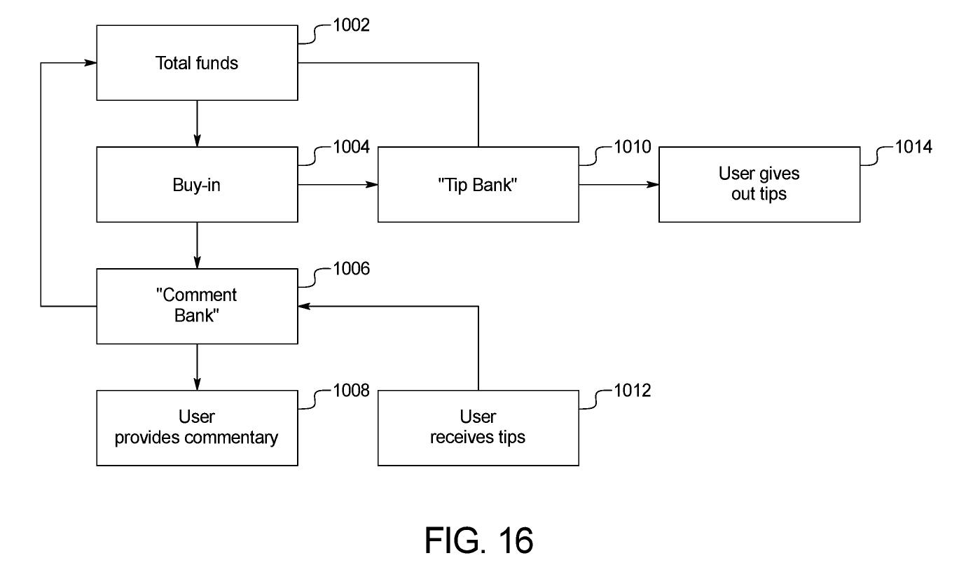

FIG. 16 illustrates how a user's funds are appropriated after the user joins a discussion via the “Buy In” window 700 as seen in FIG. 11. After depositing money via the “Add Funds” window 900 as seen in FIG. 15, the user's funds are in appropriated to a “total funds” bank 1002. When a user buys in 1004, funds are deducted from the “total funds” bank 1002. Upon buying in, the user's buy in amount will be split between a “Comment Bank” 1006 and “Tip Bank” 1008. When a user post's a comment or replies to another user's comment, funds are deducted from the user's “Comment Bank” 1006. When a user tips another user's comment, funds are deducted from the user's “Tip Bank” 1010.

If a user receives a tip, 1012, the money is added into the user's “Comment Bank” 1006. Upon expiration of the exchange, funds still present in the user's “Comment Bank” 1006 and “Tip Bank” 1010 are deposited back into the users “total funds” banks 1002. The user can than user funds from the “total funds” bank 1002 to join more exchanges.

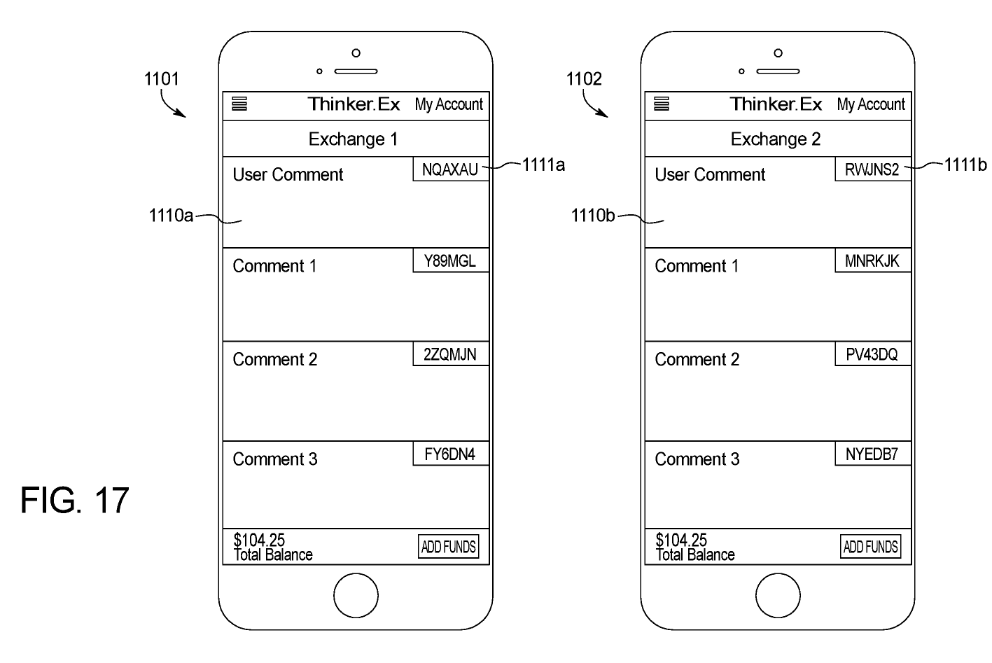

FIG. 17 illustrates the avatar-reset feature wherein a user's avatar is reset for every discussion they join. In the first exchange 1101, after the user posts a comment 1110a, the central system 108 assigns the user a first avatar 1111b. When the user joins a second exchange 1102 and posts a comment 1110b, the central system 108 assigns the user a second avatar 1111b. The first avatar 1111a is different than the second avatar 1111b.

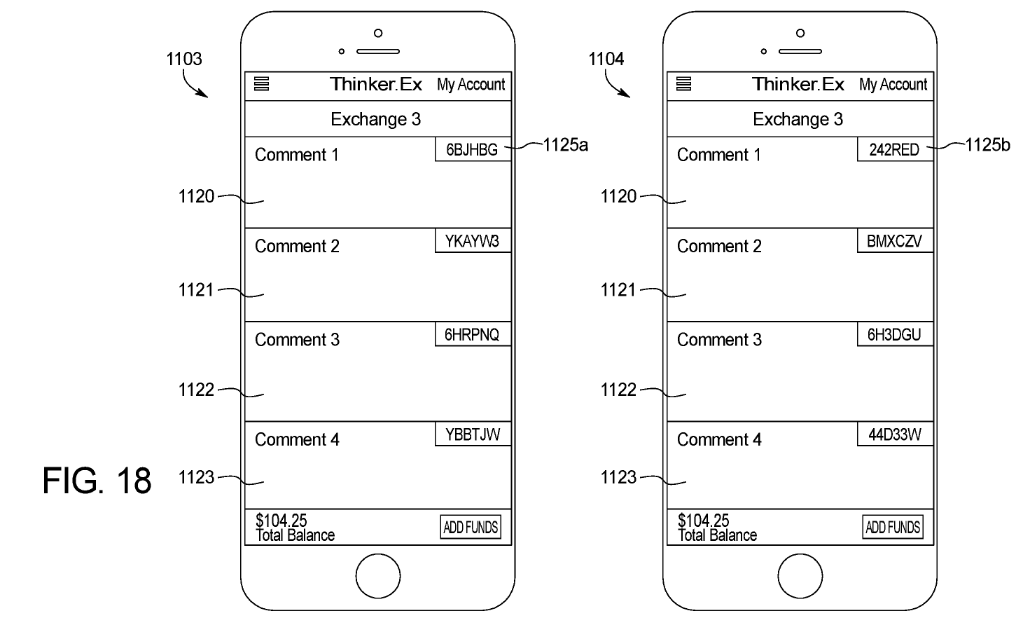

FIG. 18 illustrates the avatar-scrambler feature wherein all users in the same forum view avatars differently than each other. A first user's exchange window 1103 and a second user's exchange window 1104 both display the same comments 1120, 1121, 1122, and 1123, which were each posted by the same users. In window 1103, the comment 1120 includes an avatar 1125a, while in window 1104, the comment 1120 includes an avatar 1125b. Avatar 1125a is a different string of alphanumeric characters than avatar 1125b. Avatar 1125a is different than avatar 1125b even though both avatar's are linked to the same user comment 1120.

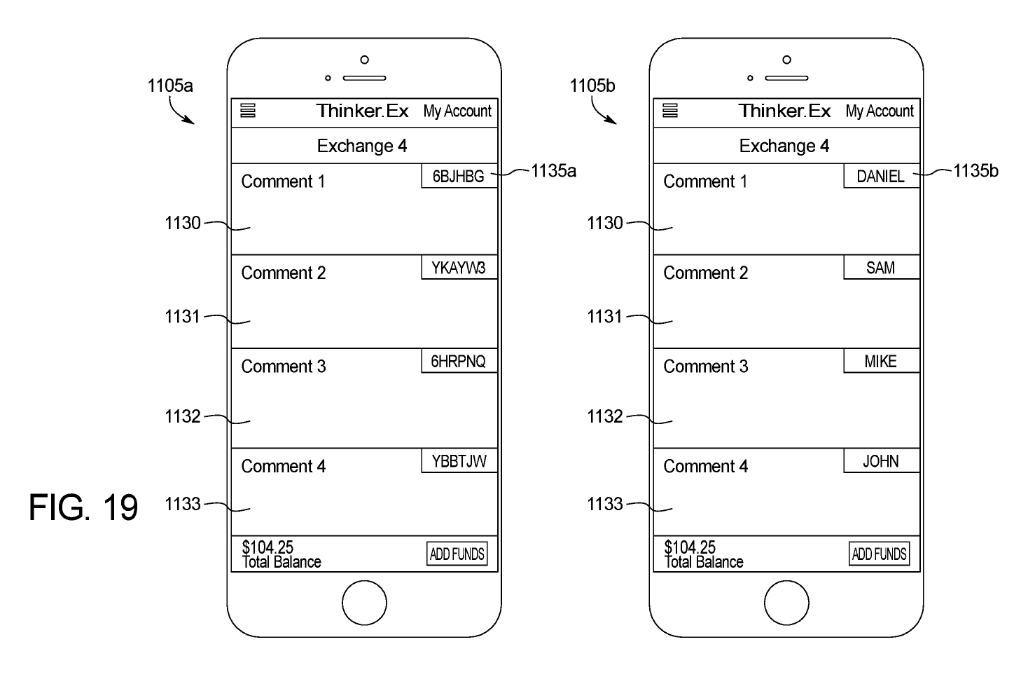

FIG. 19 illustrates the avatar-naming feature wherein a user can change the name of another's user avatar in a discussion, but in a manner in which the new name is only visible to the user changing the avatar. A user's exchange window 1105a and exchange window 1105b both display the same comments 1130, 1131, 1132, and 1134. Comment 1130 in window 1105a includes avatar 1135a, which is a string of random alphanumeric characters. Comment 1130 in window 1105b is the same comment 1130 as in window 1105a, but includes a user provided avatar 1135b. After a user changes the name of another user's avatar, further comments by that user include the user-provided avatar. In this manner, a user may be able to better visualize and recognize which post comes from which user, while each user maintains pseudonymity.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A discussion forum system comprising:
a central server in communication with a plurality of user devices in which each of the user devices provides a user interface through which an associated user communicates with the central server;
the user interfaces facilitate user participation in an online discussion forum comprising a plurality of exchanges, in which each of the plurality of exchanges is an online discussion between two or more users in which each of the two or more users is represented by a pseudonymous avatar assigned by the central server at the time each of the two or more users joins one of the plurality of exchanges;
in which at least a first user and a second user of the two or more users pay a required buy in associated with a first exchange of the plurality of exchanges to join the exchange and the value of each user's buy in is divided amongst a comment bank and a tip bank associated with each user; and
in which, prior to allowing a comment made by the first user to post to the first exchange, the central server debits a first value from the comment bank associated with the first user and, in response to the posting of the comment, provides an opportunity for the second user to reward the first user with a payment from the second user's tip bank to the first user's comment bank.

2. The system of claim 1 wherein each tip bank is associated with a single exchange and the value associated with each tip bank must be spent during the associated exchange or forfeited when the associated exchange ends.

3. The system of claim 1 wherein when more than 20% of the users in the first exchange flag the comment for removal, it is automatically removed from the first exchange.

4. The system of claim 3 wherein the central server debits a second value from the comment bank of the second user in response the second user flagging the content for removal.

5. The system of claim 4 wherein the central server credits the second value to the comment bank of the second user when the comment is automatically removed from the first exchange.

6. The system of claim 1 wherein the pseudonymous avatars assigned by the central server are consistently displayed for each user such that the pseudonymous avatar assigned by the central server to the first user is displayed consistently to the second user and to a third user.

7. The system of claim 1 wherein the pseudonymous avatars assigned by the central server are uniquely displayed for each user such that a pseudonymous avatar of the first user assigned by central server shown on a second user's user interface is not the same as a pseudonymous avatar of the first user assigned by central server shown on a third user's user interface.

8. The system of claim 1 wherein the pseudonymous avatar of first user assigned by the central server is replaced by a pseudonymous avatar of first user assigned by the second user when viewed on second user's user interface.

9. The system of claim 1 wherein the pseudonymous avatars assigned by the central server are uniquely displayed for each user in each of a plurality of discussions such that a pseudonymous avatar assigned by central server for the first user in the first exchange is not the same as a pseudonymous avatar assigned by the central server for the first user in a second exchange.

10. The system of claim 1 wherein each exchange includes a minimum number of users participating in the conversation and a maximum number of users participating in the conversation.

11. A method of providing a discussion forum comprising the steps of:
providing a central server in communication with a plurality of user devices in which each of the user devices provides a user interface through which an associated user communicates with the central server;
facilitating user participation in an online discussion forum comprising a plurality of exchanges via the user interfaces, in which each of the plurality of exchanges is an online discussion between two or more users in which each of the two or more users is represented by a pseudonymous avatar assigned by the central server at the time each of the two or more users joins one of the plurality of exchanges;
requiring at least a first user and a second user of the two or more users to pay a buy in associated with a first exchange of the plurality of exchanges to join the first exchange and the value of each user's buy in is divided amongst a comment bank and a tip bank associated with each user; and
prior to allowing a comment made by the first user to post to the first exchange, debiting, by the central server, a first value from the comment bank associated with the first user and, in response to the posting of the comment, providing an opportunity for the second user to reward the first user with a payment from the second user's tip bank to the first user's comment bank.

12. The method of claim 11 wherein each tip bank is associated with a single exchange and the value associated with each tip bank must be spent during the associated exchange or forfeited when the associated exchange ends.

13. The method of claim 11 wherein when more than 20% of the users in the first exchange flag the comment for removal, it is automatically removed from the first exchange.

14. The method of claim 13 wherein the central server debits a second value from the comment bank of the second user in response the second user flagging the content for removal.

15. The method of claim 14 wherein the central server credits the second value to the comment bank of the second user when the comment is automatically removed from the first exchange.

16. The method of claim 11 wherein the pseudonymous avatars assigned by the central server are consistently displayed for each user such that the pseudonymous avatar assigned by the central server to the first user is displayed consistently to the second user and to a third user.

17. The method of claim 11 wherein the pseudonymous avatars assigned by the central server are uniquely displayed for each user such that a pseudonymous avatar of the first user assigned by central server shown on a second user's user interface is not the same as a pseudonymous avatar of the first user assigned by central server shown on a third user's user interface.

18. The method of claim 11 wherein the pseudonymous avatar of first user assigned by the central server is replaced by a pseudonymous avatar of first user assigned by the second user when viewed on second user's user interface.

19. The method of claim 11 wherein the pseudonymous avatars assigned by the central server are uniquely displayed for each user in each of a plurality of discussions such that a pseudonymous avatar assigned by central server for the first user in the first exchange is not the same as a pseudonymous avatar assigned by the central server for the first user in a second exchange.

20. The method of claim 11 wherein each exchange includes a minimum number of users participating in the conversation and a maximum number of users participating in the conversation.
